(19) United States
(12) Patent Application Publication
(10) Pub. No.: US 2008/0078843 A1
(43) Pub. Date: Apr. 3, 2008

(54) Dosing pump, spraying device for spraying sprays and method for operating such a spraying device

(76) Inventors: Wolf-Dieter Wichmann, Neetzow (DE); Frank Gessler, Reutlingen (DE)

Correspondence Address: FLYNN THIEL BOUTELL & TANIS, P.C., 2026 RAMBLING ROAD, KALAMAZOO, MI, 49008-1631, US

(21) Appl. No.: 11/901,466

(22) Filed: Sep. 17, 2007

Related U.S. Application Data
(60) Provisional application No. 60/855,254, filed on Oct. 30, 2006.

(30) Foreign Application Priority Data
Sep. 19, 2006 (DE) 10 2006 045 450.2

(51) Int. Cl. A01G 25/09; G01F 11/28

(52) U.S. Cl. 239/1; 222/444

(57) ABSTRACT

Dosing pump.

The invention relates to a dosing pump with a feed chamber (20) connected to a liquid inlet (12) and a liquid outlet (16). Liquid inlet (12) and liquid outlet (16) can in each case be sealed by a valve (14, 18).

According to the invention the at least one valve (14, 18) is self-locking and can be unlocked by means of an unlocking device (36).

Use for spraying devices for spraying agricultural and/or plant protection sprays.

The invention relates to a dosing pump, particularly for a spraying device for spraying agricultural sprays, having at least one feed chamber with at least one liquid inlet and at least one liquid outlet. The at least one liquid inlet and/or at least one liquid outlet can be sealed with a valve. The invention also relates to a spraying device for spraying agricultural sprays having at least one dosing pump. The invention also relates to a method for operating such a spraying device.

Dosing pumps with a feed chamber and with in each case at least one liquid inlet and liquid outlet, the liquid inlet and/or liquid outlet being sealable with a valve, are known. All presently known dosing pumps in farming plant protection only have one passage direction corresponding to a feed operation. For emptying and cleaning such dosing pumps it is consequently necessary to feed a washing liquid quantity, generally water, in a normal feed operation, the washing liquid then having to displace the undiluted spray in the dosing pump and in the pipe system up to the infeed point before a dilution or washing can take place. This washing liquid feed at present usually takes place in conjunction with a washing run, in which the used, spray-contaminated washing liquid is discharged at the same time and is consequently disposed of. What is critical in this standard practice is that the clean spray volume displaced from the dosing pump and pipe system during washing liquid feed only allows a washing run on a hitherto untreated surface so as to avoid overdosing with spray. The washing run must consequently take place on a hitherto untreated surface until the undiluted content of the dosing system is discharged. Only then is it possible to discharge the spray residues from the dosing pump and pipes in a normal feed operation in highly diluted state onto a previously treated surface. It is impossible to clearly establish when the undiluted residue of clean spray has been discharged and the adequately diluted washed liquor has been fed, because the time and therefore the distance which the spraying device must cover is dependent on the previously discharged spray quantity, the travel speed and the number of nozzles used. The risk of excessive application of spray to crop plants and the soil is consequently increased and expensive spray residues cannot be used.

The problem of the invention is therefore to provide a dosing pump, a spraying device with at least one dosing pump and a method for operating such a spraying device, which are improved with respect to handling in operation, in the preparation for operation and during cleaning.

This problem is solved by a dosing pump having the features of claim 1, a spraying device with the features of claim 14 and a method for operating a spraying device according to claim 24. Advantageous and preferred developments of the invention form the subject matter of the further claims and are explained in greater detail hereinafter. Many of the following, but not yet exhaustively enumerated features and characteristics apply both to the dosing pump, the spraying device and the method. In part they are only described once, but independently thereof they apply to the dosing pump, spraying device and method. The order of the listed features is also unbinding and can instead be modified corresponding to an optimized dosing pump, an optimized spraying device and an optimized method for the use of the optimized spraying device.

The invention provides a dosing pump, particularly for a spraying device for spraying agricultural sprays, having at least one feed chamber with at least one liquid inlet and at least one liquid outlet. The at least one liquid inlet and/or at least one liquid outlet can be sealed with a valve. The at least one valve is self-locking, but can be unlocked by means of an unlocking device.

As a result of the inventive arrangement of the dosing pump with at least self-locking, but unlockable valve the advantage arises that the dosing pump can be flowed through in two directions with only a limited resistance and also outside a normal feed operation. These directions are on the one hand from the liquid inlet to the liquid outlet and on the other, in the unlocked state, from the liquid outlet to the liquid inlet of the dosing pump. The flowthrough essentially relates to the feed chamber of the dosing pump and through the unlockability of the check valves of the dosing pump numerous possibilities arise for significantly facilitating the operation of the dosing pump or a spraying device equipped therewith. Appropriately both an inlet valve and an outlet valve are constructed in self-locking, but unlockable manner. In addition, the inventive unlockability of the valves of a dosing pump allow the through-flow of a complete pipe system from the spray storage tank to the spray infeed location, also outside the normal feed operation. For this purpose it is merely necessary to provide at appropriate points in the system the necessary switching and control elements. The operation of the inventive dosing pump or a spraying device equipped therewith is consequently much more reliable from the handling standpoint.

In the case of spraying devices for plant protection for which the inventive dosing pump is more particularly provided, the dosing of a spray into a carrier liquid at a number of locations in the system and e.g. prior to the branching off into partial widths or even directly upstream of a spray nozzle by means of a so-called direct infeed takes place in hitherto known dosing systems suitable for practical use in plant protection, spray the spray either into the spray liquor pressure line or spray water pressure line just upstream of the branching to partial widths or into the liquor or mixture pump intake area. The distance of the locations for the spray infeed from the nozzles is decisive for the time and therefore the distance which must be covered by the spraying device before the desired dosing passes out of the nozzles. In order to shorten this time and distance it is important for the infeed to be as close as possible to the nozzles. As the dosing pump valves and appropriately also other valves in the system according to the invention are unlockable, it is possible prior to the start of dosing that the entire dosing system from the spray storage tank to the spray infeed location can undergo filling and the dosing pump can be vented e.g. by means of a pneumatic underpressure. This leads to the advantage that at the start of dosing the spray immediately and without delay is fed in. The advantage is also obtained that after the end of dosing the spray contained in the entire system, can be fed back e.g. by means of compressed air into the storage tank. This represents a significant advance in that no longer are there undilutable residual quantities of clean or pure spray, which cannot be discharged onto the previously treated surface. The two aforementioned advantages lead to a further important advantage of the inventive system in that the dosing pump together with the spray storage tank can be housed at any random appropriate point on the spraying device. This is completely independent of the location of spray infeed, without said spatial separation of dosing pump and infeed leading to a delay in dosing or concentration buildup. As the dosing pump valves are unlockable, apart from dosing sprays into a carrier liquid, the dosing pump can also bring about the forward feed from an active substance storage tank and the return feed of the spray into an active substance storage tank or the like. This also permits a washing of the dosing pump feed chamber.

The fluid is here considered to be any liquid including emulsions and suspensions or the like, which in turn also include the spray. The carrier liquid, which is also a fluid, generally involves water. Hereinafter the terms spray and active substance are used. Although a spray is generally a mixture of a carrier liquid and an active substance, in the present description both terms are used with the same meaning and both terms can be equivalently used within the scope of the invention. The dosing pump feed chamber is connected both to at least one liquid outlet and at least one liquid inlet.

A self-locking valve is here understood to be a valve which has one passage direction and one locking direction. A passage function is brought about in a valve according to the invention in that the unlocking device is not activated, preferably by means of a suction or pressure action produced by the dosing pump. A locking function in the case of the same valve is brought about by a pressure or suction action produced by the dosing pump. However, the locking function can also be assisted by an additional force action on the locking body of the valve or can be exclusively produced by said force action.

With the presently described dosing pumps are fed spray quantities between approximately 200 ml and approximately 6 litres per hectare to be sprayed. However, within the scope of the invention a feed range with much smaller and/or much larger quantities is also conceivable.

According to a further development of the invention each liquid inlet and each liquid outlet can be sealed with a valve.

Within the scope of the invention no importance is attached to whether several liquid inlets or liquid outlets brought together in a common pipe are jointly sealable in the common pipe or are in each case individually sealable.

According to a further development of the invention each liquid inlet and each liquid outlet can be sealed by means of a separate valve. For this purpose the valve in the liquid inlet is constructed as a suction valve and the valve in the liquid outlet as a pressure valve. Each of the valves can be separately controlled for unlocking.

According to the invention the valve has a body which is permanently subject to a force. The force applied to the valve body is preferably supplied by a closing spring.

The valve body can e.g. be constructed as a ball, cylinder, plate or the like, which can be placed on a tappet or can be subject to the action of an unlocking tappet. The valve body seals against a matching valve seat in the valve housing. The permanent force action of the valve body preferably takes place by spring tension and/or gravity and is in particular provided for the self-locking function of the valve, e.g. in the manner of a check valve.

According to a further development of the invention the unlocking device can be activated pneumatically, hydraulically and/or electrically.

As the preferred place of use of the inventive dosing pumps is a spraying device used in agriculture or plant protection and where generally tractors are used as the carrier vehicles, which must already have hydraulic and/or pneumatic systems for other purposes, for the activation by pneumatics or hydraulics of the unlocking device no further drive means have to be provided. If an electrically activatable unlocking device is provided, this can e.g. be implemented with a servomotor or an electromagnet.

According to a further development of the invention the unlocking device acts on the valve body, particularly by means of a tappet on said valve body.

The action of the unlocking device on the valve body can take place with a piston, tappet and/or magnet, the unlocking device more particularly acting in a direction which is parallel to the valve body movement direction, but counter to the force for the self-locking function.

Unlocking can e.g. also take place by means of a magnetic field, in which the valve body and/or an unlocking tappet can be moved as in a linear motor.

According to a further development of the invention the unlocking device has a return or restoring device, which in the preferred embodiment of the invention is a return spring acting on a tappet.

For the return of the unlocking device it is e.g. also possible to provide a magnet and/or a spring. The return can also take place by deactivating the activating device of the unlocking device and through the feed pressure of the dosing pump being reduced, so that the self-locking characteristics of the valve are sufficient for restoring the unlocking device.

The problem of the invention is also solved by a spraying device for spraying agricultural sprays, particularly a field sprayer, with at least one inventive dosing pump.

The spraying device has e.g. at least one group of spray nozzles with in each case one inlet, which are interconnected by means of a common supply channel, the dosing pump feeding spray directly upstream of the spray nozzle into the inlet or directly upstream of the group of spray nozzles into the supply channel. Each spray nozzle or group of spray nozzles provided in the spraying device is allocated with at least one dosing pump. The dosing pump and spray nozzles are placed in or on a common housing. In this way the dosing pump and spray nozzles form a module, which can be placed as a unit, e.g. on a spraying beam of the spraying device. Alternatively the dosing pump can be fitted to a nozzle holder. Advantageously between the liquid outlet and spray nozzle only a very small pipe length has to be provided in which is left spray to be disposed of following the use of the spraying device. The at least one dosing pump is connected by means of a spray feed pipe to an active substance storage tank and the at least one dosing pump is connectable to a compressed air pipe and/or a carrier liquid pipe. The at least one dosing pump can be placed in a ring main, which has at least one spray feed pipe from an active substance storage tank to the dosing pump and at least one active substance return pipe from the dosing pump to the active substance storage tank. This permits a forward feed operation, a return feed operation and/or a washing operation. Through the planned control of the unlocking devices for the valves it is possible to even reverse the dosing pump feed direction.

In a further development of the invention by means of the dosing pump active substance can be fed by means of an active substance infeed pipe into a carrier liquid pipe and in the vicinity of the opening of the active substance infeed pipe into the carrier liquid pipe in or on said active substance infeed pipe is provided a sensor, which at least detects the presence of fluid and emits a corresponding signal.

Such a sensor makes it possible to detect an adequate forward feed and e.g. on the basis of the sensor signal a compressed air supply can be switched off.

According to a further development of the invention a connection of the active substance infeed pipe to the carrier liquid pipe in the vicinity of the opening of the active substance infeed pipe into the carrier liquid pipe can be blocked by means of a valve, so that only in a dosing pump feed operation is there a connection between the active substance infeed pipe and the carrier liquid pipe and otherwise the carrier liquid pipe and active substance infeed pipe are reliably separated.

In this way it is e.g. possible to have a forward operation and a return operation, without having to fear active substance entering the carrier liquid pipe.

The at least one dosing pump can be connected to a compressed air pipe or a carrier liquid pipe, in order in a return operation or washing operation to remove or wash spray from the dosing pump.

An inventive method for the operation of the above-described spraying device has the step of unlocking the at least one dosing pump valve and the step of the forward feed of spray to the at least one dosing pump, the return feed of spray from the at least one dosing pump or the washing of the at least one dosing pump in the unlocked state of the at least one valve.

Further advantages and features of the invention can be gathered from the claims, as well as the following description of embodiments of the invention shown in the drawings. In part features of the embodiments are only described relative to one representation of an embodiment, but within the scope of the invention can be randomly combined with the other embodiments. In the diagrammatic drawings show:

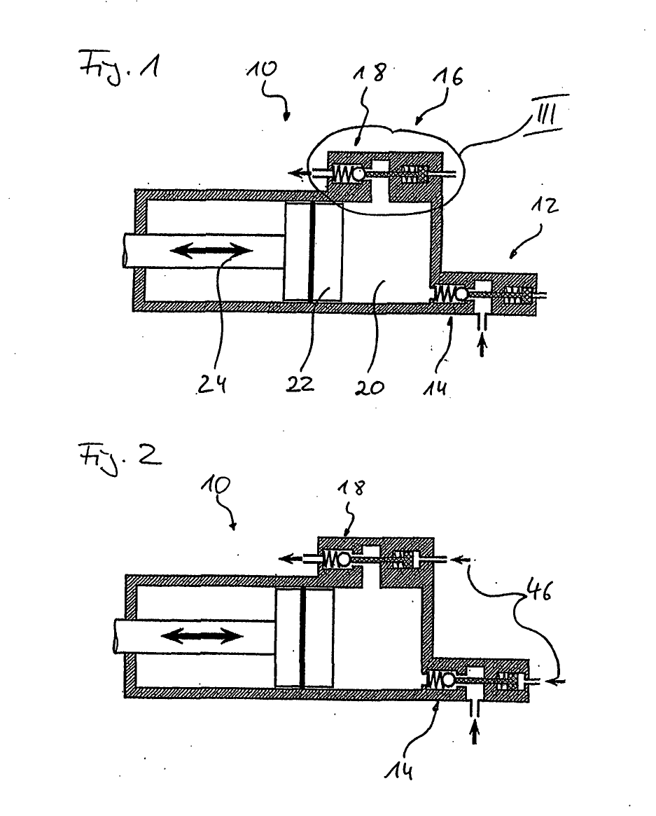

FIG. 1 A sectional side view of an inventive dosing pump with self-locking and unlockable valves in the locked state.

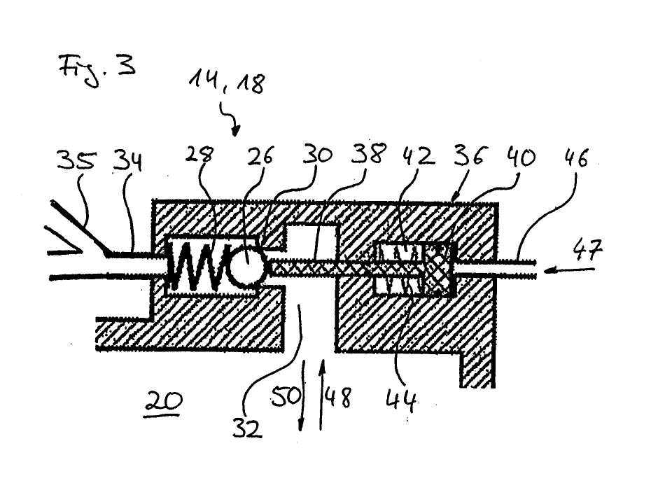

FIG. 2 A sectional side view of an inventive dosing pump with self-locking and unlockable valves in the unlocked state.

FIG. 3 A larger scale representation of detail III in FIG. 1.

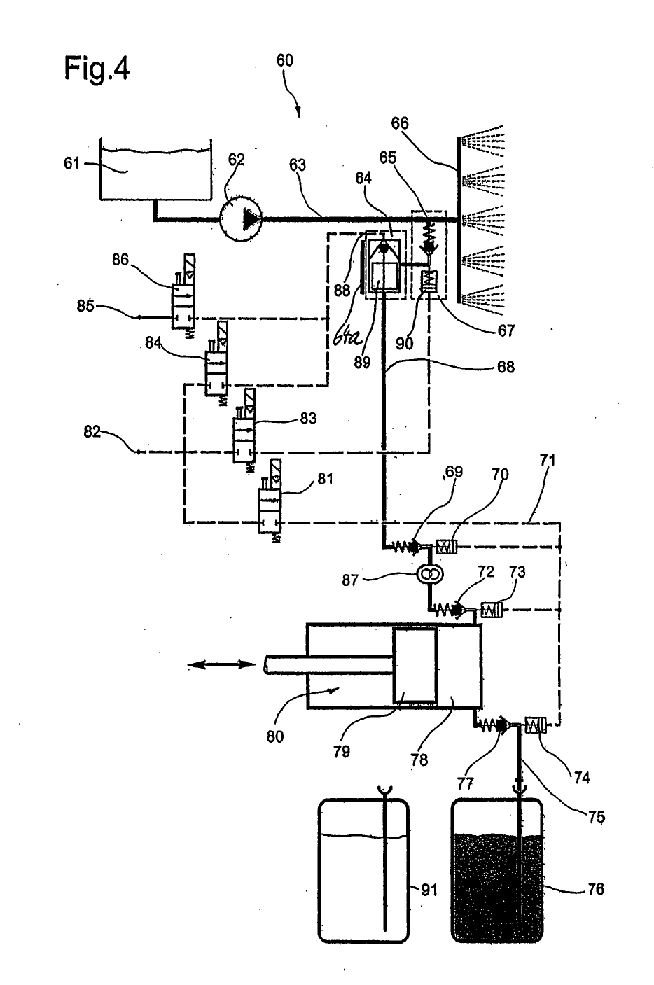

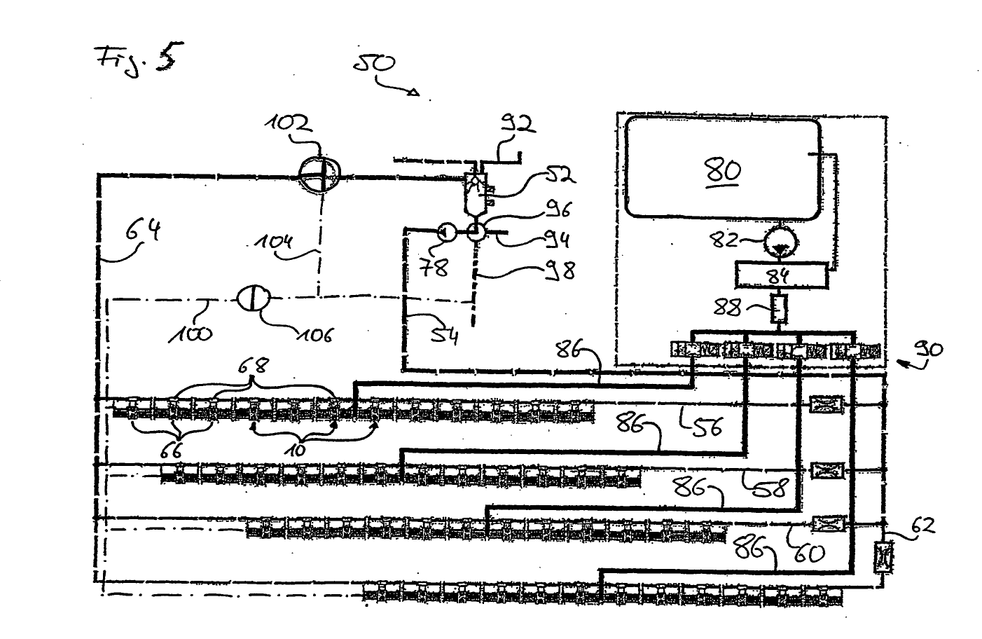

FIG. 4 An inventive spraying device according to the first embodiment.

FIG. 5 An inventive spraying device according to a second embodiment.

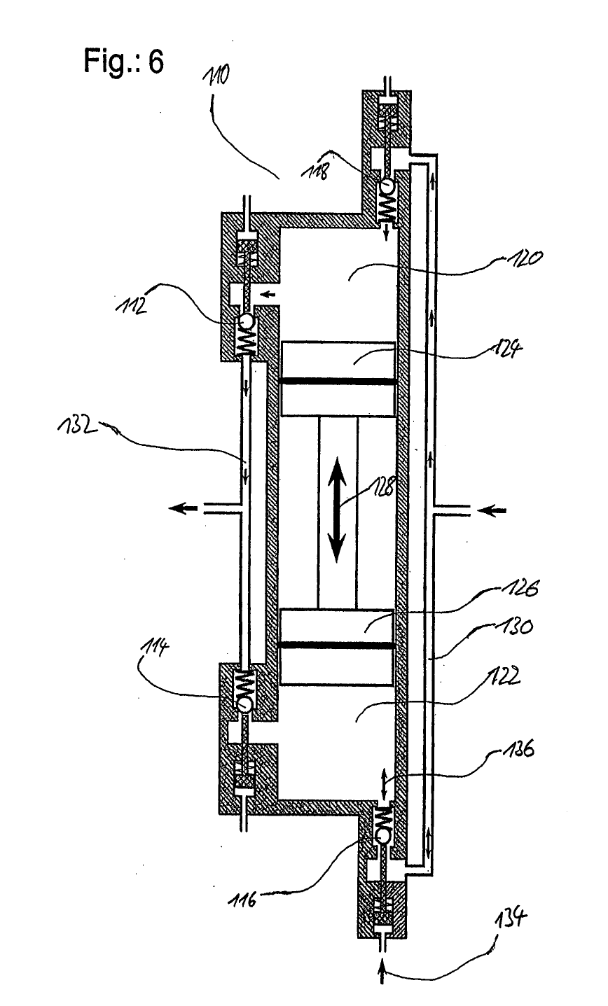

FIG. 6 A sectional side view of an inventive dosing pump in a further preferred embodiment.

Dosing pump 10 for dosing in active substances for agricultural sprays shown in FIG. 1 has in the vicinity of a liquid inlet 12 of dosing pump 10 an inlet or suction valve 14 and in the vicinity of a liquid outlet 16 of dosing pump 10 a pressure valve 18. Liquid inlet 12 and liquid outlet 16 are in each case connected to a feed chamber 20 of dosing pump 10. Within the cylindrical feed chamber 20 a piston 22 is linearly movable parallel to a median longitudinal axis of feed chamber 20. Piston 22 is connected to a piston rod 24, which is in engagement with a not shown drive. The valves 14, 18 of the dosing pump shown in FIG. 1 are represented in a state in which the dosing pump permits a normal feed operation. However, FIG. 2 shows the dosing pump valves 14, 18 in a state in which a washing or cleaning process, a forward feed operation or a return feed operation is possible.

The structure of suction valve 14 and pressure valve 18 is represented identically for simplification purposes in FIG. 1 and explained in greater detail relative to FIG. 3. Each of the valves 14, 18 e.g. has a spherical valve body 26, which by means of a helical spring 28 is forced into a valve seat 30 in order to bring about a self-locking of valves 14, 18 in the manner of a check valve. When in engagement in valve seat 30, valve body 26 separates a valve prechamber 32 from a feed pipe 34 and to the latter is connected a Y-piece 35. An unlocking device 36 can act counter to the tension of helical spring 28 and has a tappet 38 connected to a piston 40. Piston 40 is linearly movably guided in a cylinder 42 and held by a helical spring 44 in an end stop position shown in FIG. 3. By means of a pneumatic or hydraulic pipe 46 a pressure force can be exerted on piston 40 counter to the tension of helical spring 44, so that piston 40 together with tappet 38 is moved in a direction parallel to the vector 47 of the pressure force and counter to the pressure force of spring 44.

The function of valves 14, 18 is explained relative to valve 18. If the piston 22 of dosing pump 10 in FIG. 1 is moved towards the valve 14, i.e. to the right in FIG. 1, a pressure is built up in feed chamber 20 and acts in the valve prechamber 32 in accordance with arrow 48 in FIG. 3. If the pressure or the resulting pressure force on valve body 26 exceeds the spring tension of helical spring 28 valve body 26 is raised from the valve seat 30 counter to the tension of helical spring 28 and a liquid to be fed can be pumped out of the valve prechamber 32 into the feed pipe 34. In the case of an opposite movement of the piston 22, to the left in FIG. 1, an underpressure builds up in valve prechamber 32 and acts in accordance with arrow 50 in FIG. 3. Thus, if the pressure and therefore the pressure force acting on the valve body 26, e.g. through a pressure compensation or the suction action described, becomes smaller than the spring tension of helical spring 28, valve body 26 is again pressed into valve seat 30 by helical spring 26. A return flow of already fed spray from the feed pipe 34 into feed chamber 20 is in this way prevented. Valve 14 acts in the same way and prevents spray contained in feed chamber 20 flowing back into the suction channel 12. As a result during the movement to the right of piston 22 fluid is ejected from feed chamber 20 through valve 18. If the piston 22 moves to the left in FIG. 1, fluid is sucked by the valve 14 into the feed chamber.

To unlock the valve 18, a pressure force is made to act on piston 40 by pneumatic or hydraulic pipe 46. As soon as the pressure force is higher than the combined tensions of helical springs 28 and 40, piston 40 and therefore tappet 38 is moved towards the feed pipe 34. Valve body 26 is raised from the valve seat 30 and valve 18 is unlocked. If the pneumatic or hydraulic pressure of the hydraulic fluid in pipe 46 again drops below the sum of the tensions of helical springs 28 and 40, the valve body 26, if the pump piston performs no pumping movement, is forced by helical spring 28 back into valve seat 30 and by helical spring 44 piston 40 is again brought into the end stop position shown in FIG. 3.

In the unlocked state of valves 14, 18 piston 22 in FIG. 1 can no longer bring about a pumping action. In fact, if both valves 14, 18 are unlocked, during a movement of the piston liquid is only displaced in the direction of least resistance and a liquid feed is impossible. In order to bring about the intended advantages of an unlocking of valves 14, 18, there is no need for a movement of the piston and is consequently also not appropriate when the valves 14, 18 are in the unlocked state. However, a piston movement would be appropriate in the case where the dosing pump has two pistons with in each case separate feed chambers and one pump half can be switched off in order to halve the feed performance. Independently of whether the piston 22 is or is not moving, the feed chamber 20 in the unlocked state of valves 14, 18 can be flowed through both in the feed direction and in the opposite direction with only a limited flow resistance. This permits a forward feed of the active substance prior to the start of spraying, a return feed after the end of spraying and a washing process of the dosing pump.

Diagrammatic FIG. 4 shows an inventive spraying device with the components necessary for general operation, the components necessary for unlocking the pump valves and the components necessary for filling prior to feed operation and for emptying after feed operation of the dosing pump and pipes.

FIG. 4 shows an inventive spraying device 60 permitting a forward operation, a return operation and a washing operation. Spraying device 60 has a storage tank 61 for carrier liquid, normally water, which is connected by means of a carrier liquid pipe 63 to a spraying beam 66 with several spray nozzles. A carrier liquid pump 62 is placed in the carrier liquid pipe 63 between storage tank 61 and spraying beam 66. For simplification purposes components for controlling the spraying pressure applied by pump 62 are not shown. Downstream of the carrier liquid pump 62 active substance is fed into the carrier liquid pipe 63 at an infeed location 65. Said active substance is removed from an active substance storage tank 76 by means of a dosing pump 80.

Between dosing pump 80 and active substance storage tank 76 is provided an active substance suction pipe 75 and between dosing pump 80 and infeed location 65 is provided an active substance infeed pipe 68. The active substance suction or supply pipe 75 contains a suction valve 77 constructed as a check valve and unlockable by an unlocking device 74.

Downstream of dosing pump 80 is provided an outlet valve 72 also unlockable with an unlocking device 73. During a feed operation of dosing pump 80 unlocking devices 73, 74 are not activated and during a movement of piston 79 of dosing pump 80 the latter consequently sucks active substance from the active substance storage tank 76 into its feed chamber 78 and then into the active substance infeed pipe 68.

Downstream of the outlet valve 72 is provided a flowmeter 87 and downstream of the latter is provided a constant pressure valve 69, which can also be unlocked by an unlocking device 70. Constant pressure valve 69 is constructed in the manner of a per se known check valve and is only diagrammatically represented in FIG. 4. It is important that the constant pressure valve 69 has a constant opening pressure, which is independent of the counterpressure in the active substance infeed pipe between constant pressure valve 69 and infeed location 65. Thus, as soon as the pressure in the feed chamber 68 of dosing pump 80 has exceeded a predetermined value, constant pressure valve 69 opens and liquid can pass through it.

A float valve 64 is placed between constant pressure valve 69 and infeed location 64. Said float valve 64 connects an air main 88, to which can be applied an overpressure or an underpressure, to the active substance infeed pipe 68. As soon as there is spray in the vicinity of float valve 64 in active substance infeed pipe 68, a float 89 is raised and reliably blocks the connection between air main 88 and active substance infeed pipe 68. Between float valve 64 and infeed location 65 is provided a further valve, which can be opened with an unlocking device 90. This further valve 67 is closed in the rest state and is only actively opened during feed operation f dosing pump 80 using unlocking device 90. Following a control signal valve 67 makes it possible to interrupt the connection between carrier liquid pipe 63 and active substance infeed pipe 68.

In the case of the inventive spraying device 60 there is also a pneumatic overpressure connection 82 and a pneumatic underpressure connection 85. The means for producing the pneumatic overpressure or underpressure at connections 82 and 85 are not shown so as not to overburden representation. Pneumatic switching valves 81, 83, 84 and 86 are used for the distribution of the pneumatic overpressure or underpressure to the individual unlocking devices 90, 73 and 74 of the individual valves and to the air main 88.

In a forward operation in the case of the spraying device 60 according to the invention, the spray to be dosed can be fed from the active substance storage tank 76 to the infeed location 65. At the end of a feed or spraying operation spray can be fed back from the dosing pump 78 and active substance infeed pipe 78 and the active substance supply pipe 75 from infeed location 65 to active substance storage tank 76. Finally in a washing operation clean water can be sucked from a clean water tank 91 of the spraying device and washing can take place of dosing pump 80 and the entire spray-contaminated area of the spraying device 60 up to the infeed location 65.

If a forward feed is to take place of the spray prior to the start of feed operation up to infeed location 65 during a forward feed operation, valves 81 and 86 are switched to pass. As a result there is a pneumatic underpressure in air main 88 and therefore at float valve 64 and unlocking devices 70, 73, 74 of constant pressure valve 79, outlet valve 72 and suction valve 77 are subject to the action of pneumatic pressure and consequently said valves 69, 72, 77 pass into the unlocked state. Valve 67 is closed and consequently separates the active substance infeed pipe 68 from the carrier liquid pipe 63. Float valve 64 is opened, because there is no spray in the active substance infeed pipe 68. As a result of the underpressure at float valve 64, spray is sucked from storage tank 76, via unlocked suction valve 77, through feed chamber 78 of dosing pump 80, via the unlocked outlet valve 72, via flowmeter 87, via unlocked constant pressure valve 69 to the float chamber of float valve 64.

As soon as the spray reaches float 89, the latter closes float valve 64 and as a result the forward feed is ended. A sensor 64a only schematically shown in FIG. 4 detects the position of float 89 and when float 89 has closed the float valve 84, always switches off the process and switches over pneumatic valves 81, 83, 84 and 86. Thus, in a forward operation spray can be fed close to the infeed location 65 and simultaneously the feed chamber 78 of dosing pump 80 is vented.

If the sensor detects the disconnection of float valve 64, pneumatic valves 81 and 86 are switched into the locked state, so that the pneumatic underpressure at float valve 64 is switched off and the unlocking of constant pressure valve 69, outlet valve 72 and suction valve 77 is cancelled out. In accordance with its intended use, the dosing pump 80 can then assume its feed operation. If dosing pump 80 is brought into feed operation, corresponding to a movement of piston 79 from left to right and vice versa, at the same time as the feed operation is started the pneumatic valve 83 is switched through and consequently at infeed location 65 valve 67 is switched to pass, so that the passage between the active substance infeed pipe 68 and the carrier liquid pipe 63 is freed.

At the end of feed operation the spray contained in suction pipe 75, feed chamber 78, flowmeter 87 and active substance infeed pipe 68 can be returned to the active substance storage tank 76 in a return operation. To this end pneumatic valves 81 and 84 are switched to pass. If the dosing pump 80 is no longer in feed operation, valve 67 is closed and consequently separates the active substance infeed pipe 68 from the carrier liquid pipe 63. Float valve 64 is now closed because spray is present in the active substance infeed pipe. By switching pneumatic valve 61 to pass, now constant pressure valve 69, outlet valve 72 and suction valve 77 are unlocked. By switching pneumatic valve 84 to pass a pneumatic overpressure is introduced close to the infeed location 65 and specifically in float valve 64. Said pressure acts counter to the locking direction of float valve 64 and is therefore in a position to press on the same similar to a check valve and this makes it possible for compressed air to flow into the active substance infeed pipe 68.

The inflowing compressed air displaces the spray in active substance infeed pipe 68 counter to the feed direction in feed operation so that it passes into the active substance storage tank 76. Counter to the feed direction in feed operation, the unlocked constant pressure valve 69, flowmeter 87, unlocked outlet valve 72, feed chamber 78 of dosing pump 80 and unlocked suction valve 77 are subject to a through flow. On ending the switching of pneumatic valves 81 and 84 initiating said return operation, the pneumatic overpressure at float valve 64 is switched off and the unlocking of constant pressure valve 69, outlet valve 72 and suction valve 77 is cancelled out. This can e.g. also take place automatically by monitoring the speed of flowmeter 87. If the fluid has been displaced, the then free flowing compressed air leads to a significant increase in the speed of flowmeter 87. This can be detected and used as a signal for the automatic disconnection of return operation.

Following the return operation there is only spray in suction pipe 75, feed chamber 78 and active substance infeed pipe 68, where it still adheres to their walls. They can be washed out in a washing operation and consequently the spraying device 60 can be cleaned. For setting the washing operation suction pipe 75 can be connected to the clean water tank 91 and then, as described for the forward operation, clean water can be sucked close to the infeed location 65. The minor spray residues in suction pipe 75, feed chamber 78 of dosing pump 80, flowmeter 87, constant pressure valve 69 and active substance infeed pipe 68 can be diluted to an inactive dose. Subsequently it is possible to switch over to a normal feed operation of dosing pump 80 and the entire spray-contaminated area of the spraying device 60 up to infeed location 65 and also the spraying beam 66 can be washed and the resulting wash liquor can be sprayed out onto the previously treated surface. This has no advantage for the already spray-treated plants, because the resulting wash liquor only contains spray quantities diluted to such an extent as to be ineffective.

FIG. 5 shows an inventive spraying device 50, more specifically a field sprayer with several partial widths on the spraying beam and therefore a greater working width, where use is made of dosing pumps according to the invention. The spraying device 50 has a ring main. Starting from an active substance storage tank 52 the ring main comprises an active substance feed pipe 54, which is branched into individual secondary pipes 56, 58, 60, 62, and an active substance return pipe 64 in which the secondary pipes 56, 58, 60, 62 are again brought together. Active substance permanently circulates through the ring main, so that it constantly passes into the active substance storage tank 52.

Each of the secondary pipes 56, 58, 60, 62 supplies a specific number of dosing pumps 10 in nozzle holders 66 and on each nozzle holder is located at least one dosing pump 10 with in each case at least one associated spray nozzle in a common housing 68. When there are several nozzle holders 66 and consequently significant working widths it is appropriate to subdivide into several secondary pipes 56, 58, 60, 62 in order to ensure a uniform supply with active substance of all the nozzle holder dosing pumps 10. Downstream of the branching of secondary pipes 56, 58, 60, 62 from the spray feed pipe 54, but upstream of the nozzle holder 66, each secondary pipe 56, 58, 60, 62 contains a throttle valve 70, 72, 74, 76. The sum of the volume flows via all the throttle valves 70, 72, 74, 76 is appropriately roughly 20% below the average feed performance of a circulating pump 78 in order to guarantee a rapid, uniform active substance distribution. The subdivision of the ring main into several parallel secondary circuits shown in FIG. 4 can take place independently of the partial beam subdivision. In the case of smaller bar widths, it is e.g. adequate to subdivide into three secondary circuits, as a result of the tilting of a bar on which the partial beams are located.

FIG. 5 also shows the components necessary for the provision of the carrier liquid with a spraying pressure adapted appropriately to the travel speed. The carrier liquid, preferably clean water, is delivered from the carrier liquid tank 80 by means of carrier liquid pump 82. A pressure regulating unit 84 in conjunction with a not shown control unit ensures a spraying pressure adapted to the travel speed in the following carrier liquid pipes 86 leading to the spraying bar. Following onto the pressure regulating unit 84 is provided a flowmeter 88, which supplies signals to a not shown control unit. As a function of the signals of flowmeter 88, the control unit calculates the active substance quantity necessary and which is to be dosed in, subdivides said active substance quantity over the individual nozzle holder dozing pumps 10 in operation and converts the specific active substance quantity into control pulses for the dosing pumps 10 in housings 68.

Following on to flowmeter 88 there is a subdivision into individual partial widths, each partial width being blockable by means of a partial width valve 90. Partial width valves 90 are e.g. pneumatically switched and are also controlled by the not shown control unit. As can be gathered from FIG. 4, the ring main of the embodiment shown is subdivided corresponding to the subdivision of the partial widths into secondary pipes 56, 58, 60, 62.

Active substance storage tank 52 is connected to a filling pipe 92 for filling purposes and an emptying pipe 94 for emptying the active substance storage tank 52, the emptying pipe 94 being connected by a four-way valve 96 to storage tank 52. Besides issuing into storage tank 52 and emptying pipe 94, four-way valve 96 issues into the spray supply pipe 54 and into a compressed air pipe 96. In accordance with the position of the four-way valve 96 shown in FIG. 4, active substance can pass from the active substance storage tank 52 through valve 96 and circulating pump 78 into the spray supply pipe 54.

At the end of a spray run, there are generally active substance residues in pipes 54, 56, 58, 60, 62, 64 and in the dosing pumps 10, which are too great in order to permit disposal by merely draining off without giving rise to serious environmental damage. In addition, the active substances used can be very expensive. The discharge of the residual spray onto a field to be sprayed for emptying pipes 54, 56, 58, 60, 62, 64 and dosing pump 10 can however not be used as a solution for this problem, because during emptying by discharge it is not possible to ensure that at all times and at each dosing pump 10 the same and in particular necessary spray quantity is available, because no further spray is flowing or being pumped from storage tank 52. If, alternatively, the residual spray was discharged onto an already sprayed field, the spray concentration in the soil could also reach a dangerous level.

To be able to still remove from pipes 54, 56, 58, 60, 62, 64 and dosing pumps 10 residual spray following a spraying run, said four-way valves 96 can be brought into a position in which it connects the compressed air pipe 98 to the active substance feed pipe 54. If at the liquid outlets of dosing pumps 10 devices are provided by means of which the spray flow, which would run towards the spray nozzles in spraying operation, is led back into the secondary pipe 56, 58, 60, 62, the spray can be blown out of pipes 54, 56, 58, 60, 62, 64 and dosing pumps 10.

Alternatively to this, at the liquid outlets of dosing pumps 10 it is e.g. possible to provide in the manner shown in FIG. 3 Y-pieces. One arm of said pieces in each case issues at a spray nozzle or group of spray nozzles and the other arm is connected to a compressed air pipe 100 with a two-way valve 106. The two arms of the Y-pieces are in each case lockable by means of its own valve. For this alternative there is also a three-way valve 102 by means of which the active substance return pipe 64 can be connected to the compressed air pipe 104. If the arms of the Y-pieces leading to the spray nozzles are closed by means of the corresponding valves, the three-way valve 102 is so set that the active substance return pipe 64 is connected to the compressed air pipe 104 and the two-way valve 106 is so set that the not closed arms of the Y-pieces are connected to the compressed air pipe 100, the remaining spray is fed from pipe 64, dosing pumps 10, secondary pipes 56, 58, 60, 62 and active substance feed pipe 54 back into the spray storage tank 52. In this connection it is particularly advantageous to have a construction of the dosing pumps 10 with the two self-locking, but unlockable valves according to the preceding drawings, because the feed chamber can also be emptied with the valves unlocked.

Following on to the blowing out of pipes 54, 56, 58, 60, 62 and dosing pumps 10 with the feed chambers and with a corresponding design of the components used, the dosing pumps 10 and spray nozzles can be cleaned using the carrier liquid. This is largely no problem, because the spray in the spray nozzles is already diluted with carrier liquid and the volume in which the spray is present is relatively small as a result of the direct infeed.

FIG. 6 shows another preferred embodiment of an inventive dosing pump with self-locking and unlockable valves. Dosing pump 110 is also provided for dosing active substances in a field sprayer and has in all four self-locking and unlockable valves 112, 114, 116 and 118 of the same construction as described hereinbefore. Valves 112, 118 are associated with a first feed chamber 120 and valves 114, 116 with a second feed chamber 122. The first feed chamber 120 is bounded by a first piston 124 and the second feed chamber 122 by a second piston 126. Both pistons 124, 126 are jointly driven in the manner shown. This can e.g. take place by means of a piston rod linking the pistons and which moves the two interconnected pistons 124, 126 equidirectionally in the directions of double arrow 128. The two pistons 124, 126 can e.g. also be driven hydraulically, so that they would then move in opposition to one another.

In the case of the dosing pump 110, pistons 124, 126 are moved in the same direction. Thus, if piston 124 moves upwards and liquid is forced out of feed chamber 120, simultaneously liquid is sucked into feed chamber 122.

The special nature of dosing pump 110 is represented by the combination of two feed chambers 120, 122 and therefore the combination of two pumps. Piston 124, feed chamber 120 and valves 112, 118 on one side and piston 126, feed chamber 122 and valves 114, 116 in each case represent independent pumps. Valve 118 forms a suction valve and valve 112 an outlet valve for feed chamber 120. Valve 116 forms a suction valve and valve 114 an outlet valve for feed chamber 122. All valves are unlockable according to the invention. The two suction valves 118, 116 are fed from a common suction pipe 130. The two outlet valves 112, 114 feed into a common pressure pipe 132. If all the valves 112, 114, 116, 118 operate as self-locking valves and are consequently not in the unlocked state, with each movement of pistons 124, 126 a precisely defined delivery volume is sucked from the common suction pipe 130 and in the associated counter-movement ejected into the common pressure pipe 132. If, as shown in FIG. 6, the suction valve 116 is unlocked by means of the associated unlocking device, then the feed volume of dosing pump 110 can be halved, because in the unlocked state of suction valve 116 liquid is admittedly sucked from the common suction pipe 130, but during the piston return movement the liquid is forced back into the suction pipe 130, because no adequate pressure can be built up in feed chamber 122 in order to raise the body of outlet valve 114 from its valve seat. The suction and return of fluid into or out of the feed chamber 122 in the unlocked state of suction valve 116 is indicated by a double arrow 136.

Thus, if in normal operation of the dosing pump and independently of the other valves 112, 114, 118, compressed air is solely supplied to the unlocking device of suction valve 116, as indicated by arrow 134, suction valve 116 is consequently transferred into the unlocked state and a feed or delivery is no longer possible in feed chamber 122. Through the movement of piston 126 in feed chamber 122 it is no longer possible to build up an adequate pressure to open the outlet valve 114. There is only a suction and return of the medium from or to the common suction pipe 130.

As a result of this intended prevention of the feed of one of the two individual pumps of dosing pump 110, the feed capacity of dosing pump 110 can be halved, so that even greater ranges of active substances to be dosed in can be covered.

1. Dosing pump, particularly for a spraying device for spraying agricultural sprays, comprising at least one feed chamber with at least one liquid inlet and at least one liquid outlet, the at least one liquid inlet and/or the at least one liquid outlet being sealable with a valve, wherein the at least one valve is constructed in self-locking manner unlockable by means of an unlocking device.

2. Dosing pump according to claim 1, wherein each liquid inlet and each liquid outlet can be sealed by means of a valve.

3. Dosing pump according to claim 1, wherein each liquid inlet and each liquid outlet can be sealed by means of a separate valve.

4. Dosing pump according to claim 3, wherein the valve in liquid inlet is constructed as a suction valve and the valve in liquid outlet as a pressure valve.

5. Dosing pump according to claim 1, wherein each valve can be separately controlled for unlocking.

6. Dosing pump according claim 1, wherein the valve has a body which is permanently subject to force action.

7. Dosing pump according to claim 6, wherein the valve body is subject to the force of a closing spring.

8. Dosing pump according to claim 1, wherein unlocking device can be activated pneumatically, hydraulically and/or electrically.

9. Dosing pump according to claim 1, wherein the unlocking device acts on body of valve.

10. Dosing pump according to claim 9, wherein unlocking device has a tappet acting on valve body.

11. Dosing pump according to claim 10, wherein unlocking device has a restoring device.

12. Dosing pump according to claim 11, wherein the restoring device is a return spring acting on a tappet.

13. Dosing pump according to claim 1, wherein there are at least two separate feed chambers with in each case an associated feed piston and in each case at least one suction valve and one outlet valve, the outlet valves and suction valves of each feed chamber being constructed so as to be unlockable by means of an unlocking device and there are control means for the as desired unlocking of at least one of the suction valves and outlet valves in order in this way to modify the feed performance of dosing pump.

14. Spraying device for spraying plant protection sprays and in particular a field spray, comprising at least one dosing pump according to claim 1.

15. Spraying device according to claim 14, wherein by means of dosing pump active substance is fed by means of an active substance infeed pipe into a carrier liquid pipe and in the vicinity of the opening of the active substance infeed pipe into the carrier liquid pipe in or on the active substance infeed pipe is provided a sensor, which at least detects the presence of fluid and emits a corresponding signal.

16. Spraying device according to claim 15, wherein a connection between the active substance infeed pipe and the carrier liquid pipe in the vicinity of the opening of the active substance infeed pipe into the carrier liquid pipe can be blocked by means of a valve, so that only during dosing pump feed operation is there a connection between the active substance infeed pipe and the carrier liquid pipe and otherwise the carrier liquid pipe and active substance infeed pipe are reliably separated.

17. Spraying device according to claim 16, wherein the at least one dosing pump is connected by means of a spray feed pipe to an active substance storage tank and that the at least one dosing pump can be connected to a compressed air pipe and/or a carrier liquid pipe, so that in a return feed operation spray can be removed at least from the dosing pump or in a washing operation at least the dosing pump is washed.

18. Spraying device according to claim 17, wherein the compressed air pipe can be connected to the active substance infeed pipe in the vicinity of the opening of the active substance infeed pipe into the carrier liquid pipe, so that in a return feed operation spray can be removed from the active substance infeed pipe and dosing pump counter to the feed direction.

19. Spraying device according to claim 17, wherein the compressed air pipe can be connected to the active substance storage tank and/or an active substance suction pipe between the active substance storage tank and the dosing pump, so that in a forward feed operation spray is fed at least into the dosing pump and in particular up to the opening of the active substance infeed pipe into the carrier liquid pipe.

20. Spraying device according to claim 14, wherein the at least one dosing pump is connected by an active substance suction pipe to an active substance storage tank and that the at least one dosing pump can be connected to an underpressure pipe, in order in a return operation to at least remove spray from the dosing pump or in a forward operation to feed spray at least into the dosing pump and vent the same.

21. Spraying device according to claim 20, wherein the underpressure pipe can be connected to the active substance infeed pipe in the vicinity of the opening of the active substance infeed pipe into the carrier liquid pipe.

22. Spraying device according to claim 20, wherein the underpressure pipe can be connected to the active substance storage tank and/or active substance suction pipe in order to return spray from the dosing pump to the active substance storage tank in a return operation.

23. Spraying device according to claim 14, wherein in the active substance feed pipe downstream of the at least one dosing pump and in particular downstream of a flowmeter in the active substance feed pipe is provided an unlockable valve, which independently of a counterpressure present in the active substance infeed pipe or carrier liquid pipe downstream of the valve always frees a passage at a predefined, constant dosing pump feed pressure and said valve is unlockably constructed.

24. Spraying device for spraying plant protection sprays and in particular a field spray, comprising at least one dosing pump, said dosing pump having at least one feed chamber with at least one liquid inlet and at least one liquid outlet, the at least one liquid inlet and/or the at least one liquid outlet being sealable with a valve, wherein the at least one valve is constructed in self-locking manner unlockable by means of an unlocking device, wherein there are at least two separate feed chambers with in each case an associated feed piston and in each at least one suction valve and one outlet valve, the outlet valves and suction valves of each feed chamber being constructed so as to be unlockable by means of an unlocking device and there are control means for the as desired unlocking of at least one of the suction valves and the outlet valves in order in this way to modify the feed performance of dosing pump.

25. Method for operating a spraying device for spraying plant protection sprays and in particular a field spray, having at least one dosing pump with at least one feed chamber with at least one liquid inlet and at least one liquid outlet, the at least one liquid inlet and/or being sealable with a valve, wherein the at least one valve is constructed in self-locking manner unlockable by means of an unlocking device, with the following steps:
a. unlocking the at least one valve of dosing pump,
b. forward feed of spray to the at least one dosing pump, return feed of spray from the at least one dosing pump or washing the at least one dosing pump in the unlocked state of the at least one valve.
